(19) United States
(12) Patent Application Publication
(10) Pub. No.: US 2024/0384581 A1
(43) Pub. Date: Nov. 21, 2024

(54) BYPASS AND SLIDER SHOWER DOOR

(71) Applicant: KOHLER CO., Kohler, WI (US)

(72) Inventors: James Leland Marlowe, Troy, TN (US); Aleksandra Irving, Martin, TN (US); Shivraj Dattatray Magdum, Martin, TN (US); Jacob David Lockhart, Troy, TN (US); Michael Lah, Sherrills Ford, NC (US)

(21) Appl. No.: 18/657,958

(22) Filed: May 8, 2024

Related U.S. Application Data
(60) Provisional application No. 63/502,691, filed on May 17, 2023.

(51) Int. Cl. E05F 5/00; A47K 3/34; E05D 15/06

(52) U.S. Cl. CPC E05F 5/003; A47K 3/34; E05D 15/0656; E05Y 2201/688; E05Y 2900/114

(57) ABSTRACT

A slider door system is provided that may include a header, a footer opposite the header, a sliding door, and an enclosure. The header may contain a track system and at least one soft close mechanism. The sliding door may be positioned below the header and may include a bracket that extends up into the track system of the header. The enclosure may be fixedly connected to the header. The track system may guide the bracket and sliding door along the header. The bracket may engage the at least one soft close mechanism in the header. Additionally, a length of the header may be less than a length of the footer.

### CROSS-REFERENCE TO RELATED APPLICATION

The present application claims priority to U.S. Provisional Patent Application No. 63/502,691, filed May 17, 2023, entitled, “BYPASS AND SLIDER SHOWER DOOR,” the entire contents of which are hereby incorporated by reference.

### BACKGROUND

Shower doors are commonly used in the shower industry, and some of such shower doors slide to open. To prevent the sliding doors from slamming shut, some sliding doors include soft close mechanisms that are generally positioned at an upper mount on a doorframe header. However, such doorframe headers which house the soft close mechanisms generally run the width of the entire door shower system. A need exists for sliding doors with soft close mechanisms that can be positioned within a header adjoining a stationary enclosure portion of a slider door system.

### BRIEF DESCRIPTION OF DRAWINGS

FIG. 1 is a front view of an example slider door system.

FIG. 2 is a perspective view of an example header of the example slider door system.

FIG. 3 is a perspective view of internal components of the example header.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

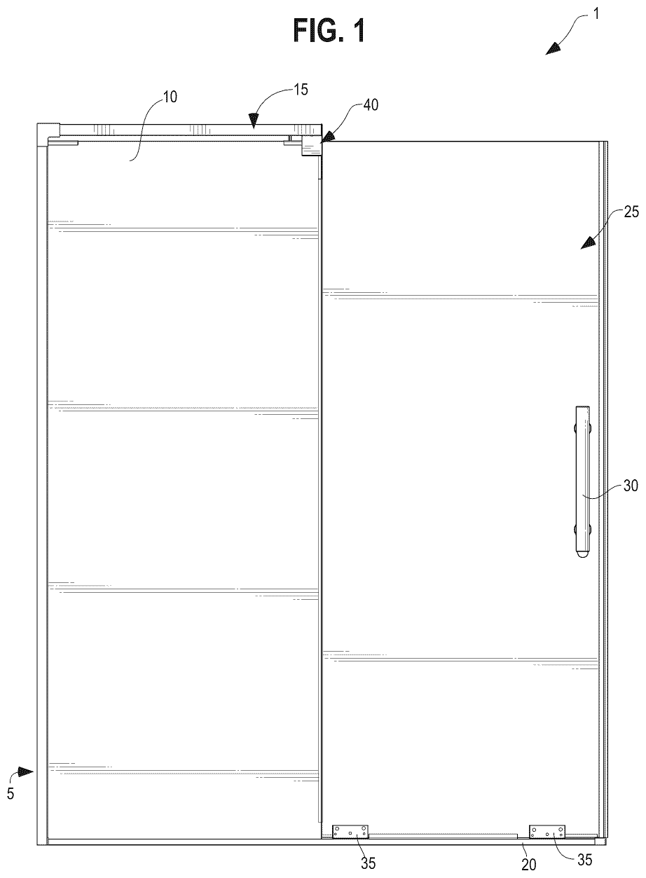

Turning first to FIG. 1, a slider door system 1 may include a doorframe 5. The doorframe 5 may house a stationary panel 10 attached to a header 15 and a footer 20 of the doorframe 5. The header 15 may be opposite the footer 20. The stationary panel 10 may be stationary, and the length of the header 15 may be shorter than the length of the footer 20. The header 15 may be the same width as the stationary panel 10, while the footer 20 may extend the width of the entire slider door system 1. The shorter length of the header 15 may allow for there to be no upper bound to at least a portion of, or a majority of, the slider door system 1. A shower door (or sliding door) 25 may be positioned below the header 15 and may be positioned to overlap partially with the stationary panel 10 on one side of the slider door system 1. The shower door 25 may slide in a direction parallel with and toward the stationary panel 10 to open. A user may use a handle 30 to slide the shower door 25 into an open position; the handle may be a standard handle, knob, towel bar, or any other handle system known in the art. The stationary panel 10 and the shower door 25 may be made of any suitable material, including glass.

The shower door 25 may be attached to the footer 20 via footer brackets 35. The footer brackets 35 may be attached to the shower door 25, and may be configured to slide along the footer 20 when the shower door 25 is slid open and/or closed. Footer brackets 35 may include rollers that roll along a track in the footer 20. The shower door 25 and the stationary panel 10 may be engaged with the header 15 via a header bracket 40 through which the shower door 25 slides. The footer 20 may also or instead include a soft close mechanism. The footer brackets 35, as guided by the footer 20, and the header bracket 40 guiding the shower door 25 may provide stabilization to the shower door 25 and the stationary panel 10.

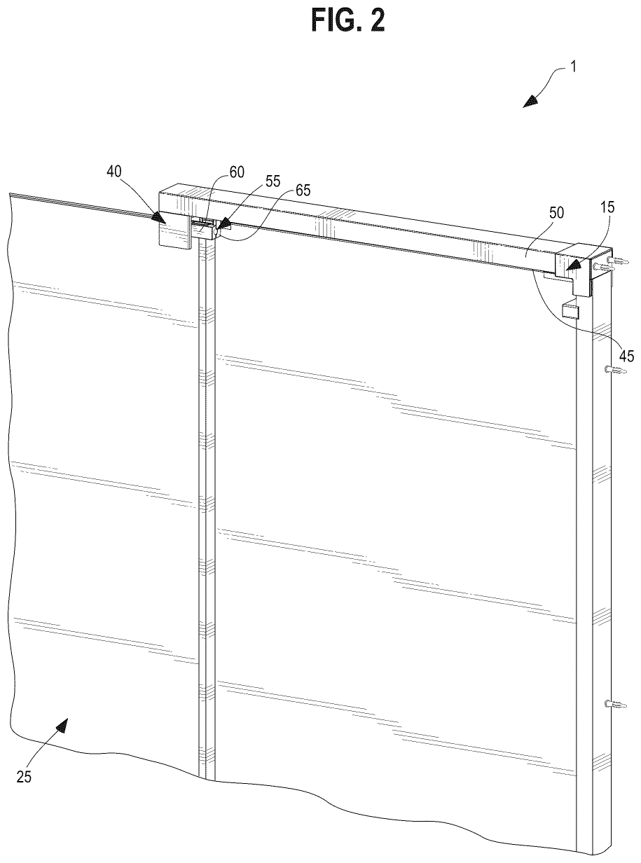

Turning to FIG. 2, a track system 45 in the header 15 may assist in guiding the shower door 25 when opened and/or closed. The header bracket 40 may cooperate with the track system 45 and may guide the shower door 25 on a side of the shower door 25 that is proximate the shower enclosure 15 when the shower door 25 is closed, and also on the inner or rear side of the slider door system 1 when viewed from outside of the shower. The header bracket 40 and track system 45 may assist in providing stability to the shower door 25. The header bracket 40 and the track system 45 may be housed within a header housing 50, or the track system 45 may be part of the header housing 50.

Additionally, an antler bracket 55 may be attached to the shower door 25. A door connection portion 60 of the antler bracket 55 may project outward from the shower door 25, and a header connection portion 65 of the antler bracket 55 may extend upward into the track system 45 of header 15. When a shower door 25 is opened and/or closed, the antler bracket 55 may slide along the track system 45. The antler bracket 55 may help in providing stability to the shower door 25 as it slides along the track system 45. The track system 45 is created by the internal profile geometry of the header 15, but could be a separate track applied to the housing 15.

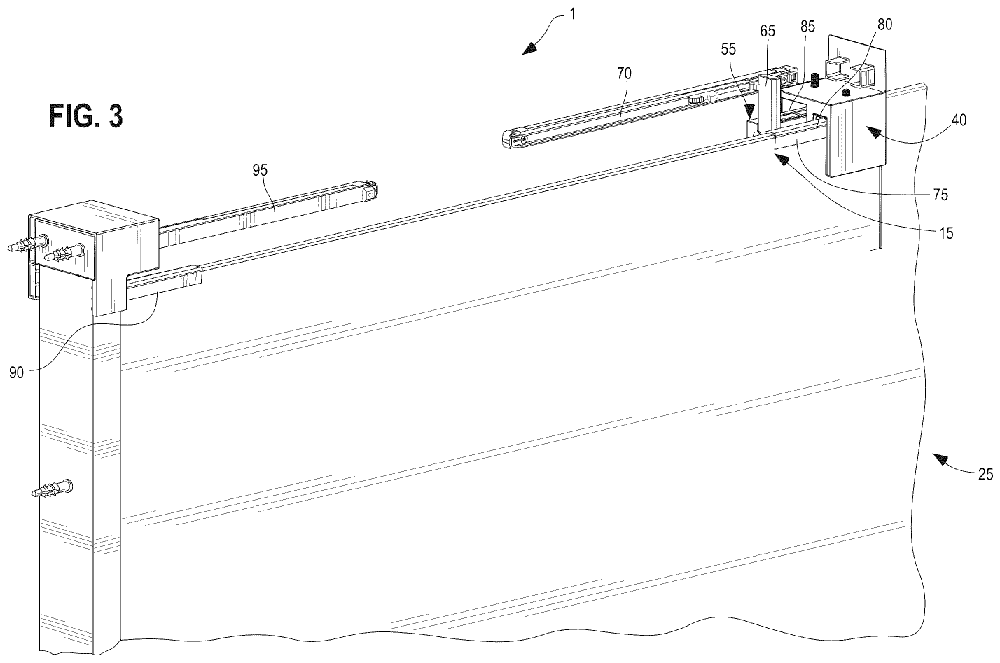

As illustrated in FIG. 3, the header housing 50 may house a soft close mechanism 70, which may be configured to prevent the shower door 25 from slamming closed. The soft close mechanism 70 may be positioned in the header 15 proximate the header bracket 40. As it slides along and within the track system 45 of the header 15, the header connection portion 65 of the antler bracket 55 may engage with a soft close mechanism 70 at a first end 75 of the header 15 when the shower door 25 is in its closed position. As such, the antler bracket 55 may transfer the soft close motion of the soft close mechanism 70 within the track system 45 to the shower door 25.

The header bracket 40 may include an enclosure compartment 80 and a door compartment 85. The enclosure compartment 80 may engage with the stationary panel 10 and provide stability to the stationary panel 10, as discussed above. The enclosure compartment 80 may be attached to the stationary panel 10 via an adhesive, frictional clamping, a pin or bolt extending through the stationary panel 10, or otherwise. The door compartment 85 may guide a portion of the shower door 25 and provide stability to the shower door 25, as discussed above. The door compartment 85 may be wide enough for the shower door 25 to slide within the door compartment 85 when the shower door 25 is opened and/or closed.

The slider door system 1 may include a soft close mechanism 95 at a second end 90 of the header 15. The soft close mechanism 95 may be integrated within the track system 45. The soft close mechanism 95 may be engaged when the shower door 25 is opened and the header connection portion 65 of the antler bracket 55 reaches the soft close mechanism 95 within the track system 45 of the header 15.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A slider door system comprising:
a header containing a track system and at least one soft close mechanism;
a footer opposite the header;
a sliding door positioned at least partially below the header, the sliding door including a bracket that extends up into the track system of the header; and
wherein a length of the header is less than a length of the footer.

2. The slider door system of claim 1, wherein the track system guides the bracket and sliding door along the header.

3. The slider door system of claim 1, wherein the bracket selectively engages the at least one soft close mechanism in the header as the sliding door is opens or closes.

4. The slider door system of claim 1, further comprising a stationary panel fixedly connected to the header.

5. The slider door system of claim 4, wherein the stationary panel is at least partially positioned below the header.

6. The slider door system of claim 4, wherein the sliding door at least partially overlaps with the stationary panel on one side of the slider door system.

7. The slider door system of claim 4, wherein the sliding door slides in a direction parallel with the stationary panel to open, and wherein the sliding door slides from a first end to a second end of the footer.

8. The slider door system of claim 1, wherein the sliding door engages with the footer via a plurality of footer brackets attached to the sliding door.

9. A slider door system comprising:
a header containing a track system and at least one soft close mechanism, the header extending from a first end to a second end, and the at least one soft close mechanism positioned proximate at least one of the first end or the second end of the header;
a footer opposite the header, the footer extending from a first end to a second end, wherein the first end of the header and the first end of the footer are vertically aligned;
a sliding door positioned at least partially below the header and at least partially above the footer, the sliding door including a bracket that extends up into the track system of the header; and
wherein the second end of the footer extends farther than the second end of the header such that the second end of the footer and the second end of the header are not vertically aligned; and
wherein the bracket selectively engages the at least one soft close mechanism in the header as the sliding door opens or closes.

10. The slider door system of claim 9, wherein the track system guides the bracket and sliding door along the header.

11. The slider door system of claim 9, further comprising a stationary panel fixedly connected to the header.

12. The slider door system of claim 9, wherein the sliding door is positioned below the header.

13. The slider door system of claim 11, wherein the sliding door at least partially overlaps with the stationary panel on one side of the slider door system.

14. The slider door system of claim 11, wherein the sliding door slides in a direction parallel with and toward the stationary panel to open.

15. The slider door system of claim 9, wherein the sliding door engages with the footer via a plurality of footer brackets attached to the sliding door.

16. The slider door system of claim 9, wherein the footer comprises at least one soft close mechanism.

17. A slider door system comprising:
a header;
a footer opposite the header;
a sliding door positioned below the header, and engaging with the header and the footer; and
wherein a length of the header is less than a length of the footer.

18. The slider door system of claim 17, wherein the header contains a track system and at least one soft close mechanism.

19. The slider door system of claim 17, wherein the footer contains at least one soft close mechanism.

20. The slider door system of claim 17, wherein the sliding door comprises a bracket that extends up into a track system of the header.
